(19) United States
(12) Patent Application Publication
(10) Pub. No.: US 2015/0097311 A1
(43) Pub. Date: Apr. 9, 2015

(54) METHOD AND DEVICE FOR GRANULATING MELTED MATERIAL

(71) Applicant: AUTOMATIK PLASTICS MACHINERY GMBH, Grossostheim (DE)

(72) Inventor: Reinhardt-Karsten Mürb, Aschaffenburg (DE)

(21) Appl. No.: 14/570,253

(22) Filed: Dec. 15, 2014

Related U.S. Application Data
(63) Continuation of application No. PCT/EP2013/001753, filed on Jun. 13, 2013.

(30) Foreign Application Priority Data
Jun. 15, 2012 (DE) 102012011894.5
Jun. 13, 2013 (EP) PCT/EP2013/001753

(51) Int. Cl. B29B 9/06

(52) U.S. Cl. CPC B29B 9/06; B29K 2827/18
USPC 264/142; 425/72.1

(57) ABSTRACT

A device and method for producing pellets from a melt material. The device comprises a perforated plate with nozzles from which a melt material emerges. The device further comprises a cutting chamber in a housing adjoining the perforated plate and enclosing at least a part of a cutter arrangement. A gaseous coolant, cooled through adiabatic expansion by means of a throttling device, flows through the cutting chamber such that pellets of the melt material are solidified. The gaseous coolant is introduced into the cutting chamber from an inlet apparatus and the gaseous coolant and the pellets located therein are conveyed to an outlet of the cutting chamber.

### CROSS REFERENCE TO RELATED APPLICATIONS

The present patent application is a Continuation application that claims priority to and the benefit of co-pending International Patent Application No. PCT/EP2013/001753, filed Jun. 13, 2013, entitled “METHOD AND DEVICE FOR GRANULATING MELTED MATERIAL”, which claims priority to DE Application No. 102012011894.5 filed Jun. 15, 2012, entitled “METHOD AND DEVICE FOR GRANULATING MELTED MATERIAL”. These references are incorporated in their entirety herein.

### FIELD

The present embodiments generally relate to a method and a device for granulating melt material, such as a melt material comprising an active pharmaceutical ingredient or a polymer melt material. The device can produce pellets of the material for use in various processes, such as manufacturing pharmaceutical products.

### BACKGROUND

Melt material in general today can be processed and treated through granulation. Extruders or melt pumps are frequently used in the granulation of melt material, such as for granulation of plastics. These extruders or melt pumps press molten plastic raw material through nozzles of a perforated plate into a coolant, such as water.

In this process, the material emerging through the openings of the nozzles is cut by a cutter arrangement with at least one rotating blade to produce pellets. Corresponding devices, which carry out methods for underwater granulation, for example, are known as underwater pelletizers, for example under the product name SPHERO™ from Automatik Plastics Machinery GmbH of Germany.

Applicant has previously disclosed a method and a device for granulating thermoplastic material, wherein a flow-optimized, radial inflow of a cooling fluid is provided in order to reduce energy expenditure for the cutter drive in cooling fluid. Special solutions to the problems of manufacturing pharmaceutical products while incorporating an appropriate design are not addressed there.

In the manufacture of pharmaceutical products from a melt material, what is critically important is uniform size, weight, and shape of products. In addition, large quantities are often desired, which makes it necessary for an appropriate production method to run reliably for a very large number of pellets (for example, up to 50 million pieces per hour).

Prior art describes a solid extended release drug form in which shaping takes place after extrusion of an appropriate melt composition from an extruder and a die plate using so-called hot-cut pelletization, where the intent is to obtain particles that are a specific shape, such as spherical. However, the feasibility of the manufacturing process is not addressed for large quantities of pellets to be produced under real production conditions.

Systems for carrying out hot-cut pelletization in air as the coolant have been on the market for quite a long time, since they represent relatively easy-to-build machines for pelletizing extruded thermoplastics. In these machines, strands of melt emerging from a perforated plate are chopped by blades rotating as closely as possible to the surface, and are formed into pellets by the inertia inherent in the small pieces of strand material. As a result of the rotation of the blades, air is drawn in from the environment or the interior of the housing, and the air directs the pellets more or less freely and centripetally away from the cutting location.

Typical problems in these systems relate to poor cooling of the blades, which over the course of time can overheat and stick, as well as a tendency for general sticking and clogging of the systems, especially at high throughput rates with large quantities of pellets to be produced under real world conditions.

Furthermore, pellets produced in this way tend to have cylindrical and irregular shapes, especially when the viscosity of the melt material is relatively high. In the case of pharmaceutical materials in particular, a great many pellets of uniform size and shape are more likely to be required in the downstream applications. Furthermore, pharmaceutical applications often require spherical pellets.

When using the hot-cut pelletization method, a molten polymer matrix, is pressed through an arrangement of one or more nozzles terminating in a flat surface over which passes a cutter arrangement consisting of one or more blades. The emerging strand is cut by the blade or blades into small units, called pellets, each of which is initially still molten.

Subsequently the pellets are cooled to below the solidification temperature of the polymer matrix so that they solidify. As pellets solidify, they doing lose the inherent stickiness of the melt and the tendency to adhere to surfaces or other pellets.

In accordance with the prior art, a distinction is made here between methods that use a liquid coolant, known as underwater hot die-face pelletizing, and those that do not use a liquid coolant, known as air-cooled hot die-face pelletizing. Air-cooled hot die-face pelletizing can refer to the cooling of pellets without a liquid medium, or with a mist consisting of a mixture of a gas and droplets of a liquid.

The latter group is further differentiated by the type of additional cooling method that is downstream in terms of processing, such as water ring pelletizers, in which a water film flows over the wall of the cutting chamber, which has a more or less cylindrical to truncated conical shape, for pellets to drop into and for transportation out of the cutting device.

If contact with water is undesirable for products to be granulated, pelletizers are used in which the freshly cut, still molten pellets are cooled exclusively by the cooling and transport gas. It is nonetheless typical in pelletizing machines that the freshly cut pellets are accelerated radially outward by the centrifugal force of the cutter arrangement, and also that the cooling process proceeds relatively slowly. Therefore, pellets must travel a relatively long distance in free flight before being allowed to come into contact with a surface.

As a result, such pelletizers are very large, even for low throughputs. The large size and the relatively low coolant gas flow rate results in internal turbulent flow, causing pellets to come into contact with the housing parts and other machine parts before they are cooled, where they can stick.

Moreover, ambient air is typically drawn in as the coolant gas. Ambient air can be laden with dust and undesirable substances, and often it is difficult (if not impossible) to monitor the temperature, moisture content, and freedom from dust properties.

Therefore, in order to achieve operation of a pelletizer that is as trouble-free as possible, it would be desirable for the pellets to cool sufficiently rapidly that they already have a solidified surface before they come into contact with housing or cutter parts or with other pellets.

The cooling rate is primarily a function of the temperature gradient and secondarily a function of the rapid exchange of volume elements of the gas with one another, which is referred to in the technical field as the degree of turbulence. The Reynolds number can be used as the parameter for the degree of turbulence. In this context, the cooling effect depends primarily on the properties of the polymer melt (specifically temperature, thermal capacity, surface, thermal conductivity, particle size, and specific surface), and of the coolant gas itself (specifically temperature, thermal capacity, degree of turbulence, coolant gas/polymer pellet mass flow ratio).

Most of these factors are either material constants or parameters determined by the process technology, so only a few possibilities exist for influencing the intensity of the cooling effect. In the final analysis, the heat content of the polymer pellets must be transferred to the coolant gas. If heat exchange with the housing parts and other machine parts is disregarded, the heat content difference in the melt material is equal to the heat content difference in the coolant gas.

Cooling the air to below the typical ambient temperature of 25 to 40° C. would be highly desirable, since the temperature gradient from air to the polymer can be increased, thereby proportionally increasing the speed of cooling for the surface of the pellets. Consequently the requisite free flight distance for pellet cooling is reduced.

The object of the present invention is to provide method and a device for granulating melt material that overcomes the disadvantages of the prior art and that allows effective pelletizing that is flexible in application, generating uniform pellet size as well as uniform and consistent shape, in a manner that is economical and structurally simple to build, while reducing the tendency of pellets to stick.

These and other objects of the present invention are attained by the present embodiments.

### BRIEF DESCRIPTION OF THE DRAWINGS

The detailed description will be better understood in conjunction with the accompanying drawings as follows:

FIG. 1 is a schematic, longitudinal cross-sectional view of a granulating device for carrying out the method according to the invention.

FIG. 2 is a schematic cross-sectional view of a granulating device according to a second embodiment for carrying out the method according to the invention.

FIG. 3 is a schematic cross-sectional view of a granulating device according to a third embodiment for carrying out the method according to the invention.

The present embodiments are detailed below with reference to the listed Figure.

### DETAILED DESCRIPTION OF THE EMBODIMENTS

Before explaining the present method and apparatus in detail, it is to be understood that the method and apparatus are not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The present invention relates to method and a device for granulating melt material. The device can have a perforated plate with nozzles located therein from which the melt material emerges. A motor-driven cutter arrangement having a cutter head with at least one blade and a cutter shaft can be located opposite the perforated plate. The at least one blade of the cutter head passes over the nozzles in the perforated plate in a rotating manner and cuts pellets of the melt material emerging there.

The device can have a cutting chamber in a housing. The chamber can adjoin the perforated plate and enclose the at least one blade of the cutter arrangement. A coolant such as air or water can be introduced into the cutting chamber from an inlet apparatus so that in the process the pellets of the melt material are solidified in the coolant.

The coolant can be further cooled through adiabatic expansion by means of a throttling device. The adiabatic expansion can be accomplished by means of the inlet apparatus implemented as a throttling device when the coolant enters the cutting chamber, or the adiabatic expansion cooling preferably can be accomplished according to the invention before the coolant enters the cutting chamber by means of a throttling device located upstream thereof.

Without the need for additional cooling units, therefore, the provision of gaseous cooling fluid cooled by throttling is made possible in the immediate vicinity of the required cooling effect merely by exploiting the applicable physical processes of adiabatic expansion.

The inlet apparatus can have a separate inlet chamber that circumferentially encloses the cutting chamber in the area of rotation of the at least one blade, an inlet nozzle arrangement located circumferentially around the cutting chamber between the inlet chamber and the cutting chamber. Coolant can therefore be introduced there into the cutting chamber circumferentially from different sides in a substantially radially inward manner.

A substantially centripetal flow of the coolant is produced in the area of rotation, and subsequently the coolant and the pellets are conveyed to an outlet of the cutting chamber.

The gaseous coolant can be air, an inert gas such as nitrogen, or a reaction gas, which is selected such that it can enter into a desired chemical reaction with the pharmaceutical melt material to be granulated. The flow of coolant can be circumferentially uniform and remains substantially constant over the circumference. The coolant is optimally cooled by adiabatic cooling and the rate can be adjusted with an appropriately designed inlet chamber and by the inlet nozzle arrangement.

The coolant or cooling fluid required for cooling and carrying away the freshly cut pellets, specifically with consideration of the moisture sensitivity that is usually present in pharmaceutical materials, is cooled and supplied to the granulating device in such a manner that a high specific throughput of material (large quantities of relatively small pellets) is possible, while at the same time avoiding clumping of the pellets.

As a result of the appropriate design of the inlet apparatus, the gaseous coolant can, along with the adiabatic expansion for cooling, also be given an (additional) rotational speed upon entry to the housing or upon entry to the cutting chamber that corresponds approximately to the rotational speed of the at least one blade of the cutter arrangement.

The acceleration of the gaseous coolant to the desired speed that takes place in this process, can be provided from adjusting the pressure of the gaseous coolant. The additional rotational speed of the gaseous coolant, can be adjusted either mechanically by means of the design of the inlet nozzle arrangement or through controlling the flow rate of the gaseous coolant, and can be matched to various other process parameters, such as material flow rate, type of melt material to be granulated, size of the pellets, and the like. The number and speed of the blade/blades can also be adjusted accordingly by persons having ordinary skill in the art.

The adiabatically cooled gaseous coolant can flow into the area of rotation with approximately the same speed as the rotational speed of the at least one blade. The coolant can flow through the at least one blade, or through intermediate spaces between multiple blades, of the cutter arrangement and carry the freshly cut pellets out of the area of rotation. This can reliably prevent sticking of the pellets even at relatively high flow rates.

In the resultant flow, as the axis of rotation of the at least one blade of the cutter arrangement is approached the corresponding rotational speed of the gaseous coolant will increase and thus the corresponding centrifugal force will increase, so that the inward flow movement from outside becomes progressively more difficult and is ultimately prevented. The gaseous coolant can then flow into the space behind the at least one blade of the cutter arrangement and in this process will flow away from the area of the perforated plate and the area of rotation in the housing in a helical flow.

In order to avoid compression shocks that would raise the temperature of the gaseous coolant again, the gaseous coolant can be routed such that, at the mass flow required for cooling the melt throughput, its flow creates a pressure drop equal to the supply pressure above atmospheric pressure, and the local speed of sound of the gaseous coolant is not exceeded at any point.

The flow control of the gaseous coolant can straighten perpendicular to the perforated plate and flow away. Pellets produced there are thus blown away from the perforated plate in a perpendicular to helical direction. The volume flow rate of the gaseous coolant and transport medium cooled is chosen such that the pellets are immediately separated after cutting, and in great excess.

For example, every hour 4 kg polymer or pharmaceutical melt material with a density of 1,200 kg/m³ emerges from a perforated plate having 24 perforations and a reference diameter of approximately 60 mm, and is cut by 9 blades with n=3,900 rpm into 13,900 pellets per second having a diameter of 0.5 mm. The pellets should have a distance of approximately 1 cm from one another in all directions. The mass flow rate of the gaseous cooling and transport medium is approximately 8 kg/h here and carries 4 kg/h transported material, which corresponds to a ratio of transported material to transport medium (“loading”) of 0.5. This is far less than is customary in pneumatic transport, where even in dilute phase conveying a loading ratio of 10 to 20 is customary, and in dense-phase conveying a loading ratio of 60 and higher is customary.

It is also possible in the method according to the invention for a flow rate, a pressure, or a direction of the gaseous coolant delivered through the inlet apparatus to be controlled by means of a control unit such that the adiabatic expansion, and thus the temperature of the coolant in the cutting chamber, is regulated.

The ratio in the housing of the mass flow rate of the gaseous coolant to the mass flow rate of the pellets located therein can be a loading ratio, defined as the mass of pellets per hour to the mass of the gaseous coolant per hour, in the range from 0.3 to 0.7. Sticking of pellets can thus be avoided reliably, even at high flow rates, since sufficient coolant is present to surround the pellets individually without clumping to cool and transport them.

After the region of rotation, the pellets located in the adiabatically cooled gaseous coolant can flow onward into the region of the cutting chamber outlet, where they can directed against a wall of the cutting chamber at a desired angle, so that a rolling motion is imposed on the pellets located in the gaseous coolant there. Consequently, the uniform shaping of the pellets can be reliably achieved.

The gaseous coolant can be air, an inert gas, or a reaction gas that is selected such that it can enter into a desired chemical reaction with the melt material to be granulated. The melt material can be a material or material mixture with an active pharmaceutical ingredient.

The device for producing pellets from a melt material can have a perforated plate with nozzles located therein from which the melt material emerges. A motor-driven cutter arrangement having a cutter head with at least one blade and a cutter shaft can be located opposite the perforated plate. The at least one blade of the cutter head passes over the nozzles in the perforated plate in a rotating manner and cuts pellets of the melt material emerging there.

The device can have a cutting chamber in a housing. The chamber can adjoin the perforated plate and enclose the at least one blade of the cutter arrangement. A coolant such as air or water can be introduced into the cutting chamber from an inlet apparatus so that in the process the pellets of the melt material are solidified in the coolant. A throttling device can be provided such that it cools the gaseous coolant by adiabatic expansion.

The inlet apparatus can have a separate inlet chamber that circumferentially encloses the cutting chamber in the area of rotation of the at least one blade, an inlet nozzle arrangement located circumferentially around the cutting chamber between the inlet chamber and the cutting chamber. Coolant can therefore be introduced there into the cutting chamber circumferentially from different sides in a substantially radially inward manner.

A substantially centripetal flow of the coolant is produced in the area of rotation, and subsequently the coolant and the pellets are conveyed to an outlet of the cutting chamber. According to the invention, in this design the inlet nozzle arrangement is implemented as an annular slot nozzle with an adjustable slot width, allowing for adjustment of coolant flow, and selection of pellet sizes through such adjustment.

With the present invention, it is possible to adjust the volume flow rate of the cooling and transport medium by adjusting the slot width of a slot nozzle. Persons having ordinary skill in the art will be able to select a flow rate such that the pellets are immediately separated after cutting, and can be accomplished at very high rates.

The slot nozzle, the inlet chamber, or both can be lined with a thermally insulating material or a nonstick material, such as a tetrafluoroethylene, a polytetrafluoroethylene, often referred to as Teflon®. The lining can also be a vitreous enamel. By using such an insulant, the coolant passing through there can be protected from unwanted heating. Nonstick linings can prevent clogging of the slot nozzle by deposits of melt material or other debris that can accumulate there.

Inlet nozzle arrangement can be implemented as an annular slot nozzle that has an adjustable slot width so that it forms the throttling device. Therefore cooling of the gaseous cooling fluid through adiabatic expansion takes place directly at the location where application of cooling is required upon entry into the cutting chamber.

A needle valve with an adjustable opening can also be provided upstream of an inlet opening for the coolant in the inlet chamber such that it forms the throttling device. This design has the advantage that a standardized component, such as a needle valve, permits the adiabatic cooling according to the invention of the gaseous cooling fluid.

The solidification of the pellets can additionally be aided by the means that the wall of the cutting chamber is cooled, for example in a double-walled design of a housing through which cooling fluid flows.

For further flow optimization in the region of the outlet, the outlet can be located in the region of the cutting chamber facing away from the inlet apparatus. A uniform outflow of the gaseous coolant with the pellets of melt material contained can thus be achieved, thereby avoiding possible clumping in the cutting chamber, and particularly in the region of the outlet. The pellets can be collected in a discharge spiral and carried away from the housing tangentially.

The features and advantages explained with regard to the method according to the invention also apply to the device and vice versa.

The present invention enables utilization of the temperature-reducing adiabatic expansion of a gaseous coolant substantially directly for cooling the pellets in the cutting chamber. The temperature of the gaseous cooling fluid can be reduced sharply and below the ambient temperature.

It can be economical that the gaseous cooling fluid be supplied under the type of conditions customary for compressed air networks, which is to say at approximately 6 bar line pressure and ambient temperature. As a result of the adiabatic expansion, a significant cooling of the gaseous cooling fluid, such as by 125° C., can nevertheless be achieved without additional cooling units.

The invention is explained in detail below by way of example with reference to the attached figures and with reference to the cited examples.

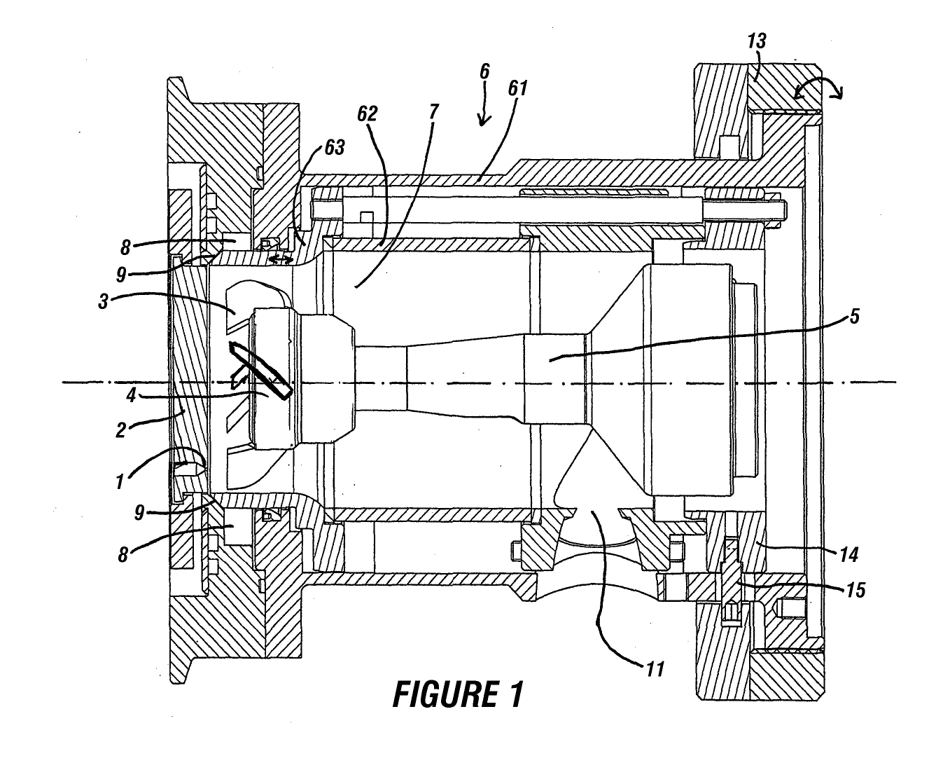

Turning now to the Figures, FIG. 1 is a schematic, longitudinal cross-sectional view of a granulating device for carrying out the method according to the invention.

The granulating device shown schematically in FIG. 1 has a perforated plate 2 with a plurality of nozzles 1 provided therein. The arrangement of the nozzles 1 can be substantially rotationally symmetric and the remaining design of the device can also be substantially rotationally symmetric.

A cutter arrangement with at least one blade 3 can be place adjacent the perforated plate 2. The cutter arrangement can have a blade carrier 4, located on a blade shaft 5. The cutter arrangement is driven by a motor (not shown in FIG. 1), so that the at least one blade 3 passes over the nozzles 1 in the perforated plate 2 and in so doing cuts pellets melt material emerging from the nozzles 2.

The melt material can be melted in a conventional manner and can be transported, for example by an extruder or a melt pump (not shown in FIG. 1), to the area of the perforated plate 2 and be forced out of the nozzles 1 there. The device can have a cutting chamber 7 adjoining the perforated plate 2 in a housing 6 with an outer housing region 61 and an inner housing region 62.

During operation, the cutting chamber 7 can be filled with a coolant, such as air or water that also flows therethrough. The cutting chamber 7 can enclose the at least one blade 3 and the blade carrier as well as at least a portion of the blade shaft 5. The blade shaft 5 can be passed out of the housing 6 in the part of the housing facing away from the perforated plate 2 in a fluid-tight manner, and a motor (not shown in FIG. 1) can rotationally drive the at least one blade 3 via the cutter shaft 5.

The inlet apparatus can be provided having a separate inlet chamber 8 that circumferentially encloses the cutting chamber 7 in the area of rotation of the at least one blade 3, and having an inlet nozzle arrangement 9 placed to extend circumferentially between the inlet chamber 8 and the cutting chamber 7.

The inlet nozzle arrangement 9 in the embodiment shown in FIG. 1 is a circumferentially extending annular gap nozzle with an adjustable nozzle width that is constant over the circumference. In the embodiment shown, the inlet chamber 8 has a cross-section that decreases over its circumference, i.e., circumferentially, in the direction of rotation of the at least one blade 3, starting from an inlet opening 10 for the coolant in the inlet chamber 8.

In this embodiment, a circumferentially uniform flow rate of coolant flows through the inlet nozzle arrangement 9. The inlet nozzle arrangement 9 there can be implemented as a throttling device by adjusting the nozzle width, through which the coolant adiabatically expands and cools.

Due to the annular design of the inlet nozzle arrangement 9 between the inlet chamber 8 and the cutting chamber 7, the coolant is introduced into the cutting chamber 7 circumferentially from all sides substantially radially inward from the outside. In this process, a substantially centripetal flow of the coolant is produced in the area of rotation of the at least one blade 3.

The inlet nozzle arrangement 9 in this embodiment is designed as an annular slot nozzle with adjustable slot width such that in the circumferential direction it is always possible for the coolant to flow from all regions of the circumferential inlet chamber 8.

The adjustability of the slot width of the inlet nozzle arrangement 9 can result from a possible displacement of the wall element 6c that encloses the cutting chamber 7 at least in the area of rotation of the at least one blade 3.

The wall element 6c can have a first nozzle surface facing away from the perforated plate 2, and can be displaced in the axial direction of the arrangement as a whole (double-headed arrow in FIG. 1) relative to the outer housing part 6a, and thus also relative to the nozzle surface of the inlet nozzle arrangement 9 present on the side of the perforated plate 2. This axial movement can be accomplished by means of the inner housing parts 6b connected thereto, an inner ring 14, as well as a rotatable Vernier screw 13 in this embodiment (double-headed arrow in FIG. 1).

Other adjustment means can be substituted. For example, instead of the arrangement shown with the Vernier screw 13, axial adjustment of the slot width of the inlet nozzle arrangement 9 can also be implemented through a gate guide in the housing 6 (not shown in FIG. 1).

By means of the adjustable slot width, the geometry of the inlet nozzle arrangement can be selected such that the inlet nozzle arrangement can serve as a throttling arrangement for the cooling fluid entering the cutting chamber 7 through it. The coolant adiabatically expands, and thus cools, while passing therethrough when the slot width is suitable.

An outlet 11 can be located in the region of the cutting chamber 7 facing away from the inlet apparatus. After the rotation region, the coolant with the pellets located therein flows onward into the region of the outlet 11 of the cutting chamber 7, where they are directed against a wall of the cutting chamber 7 at a desired angle, such as 10 degrees or less, so that a rolling motion is imposed on the pellets of melt material located in the coolant there.

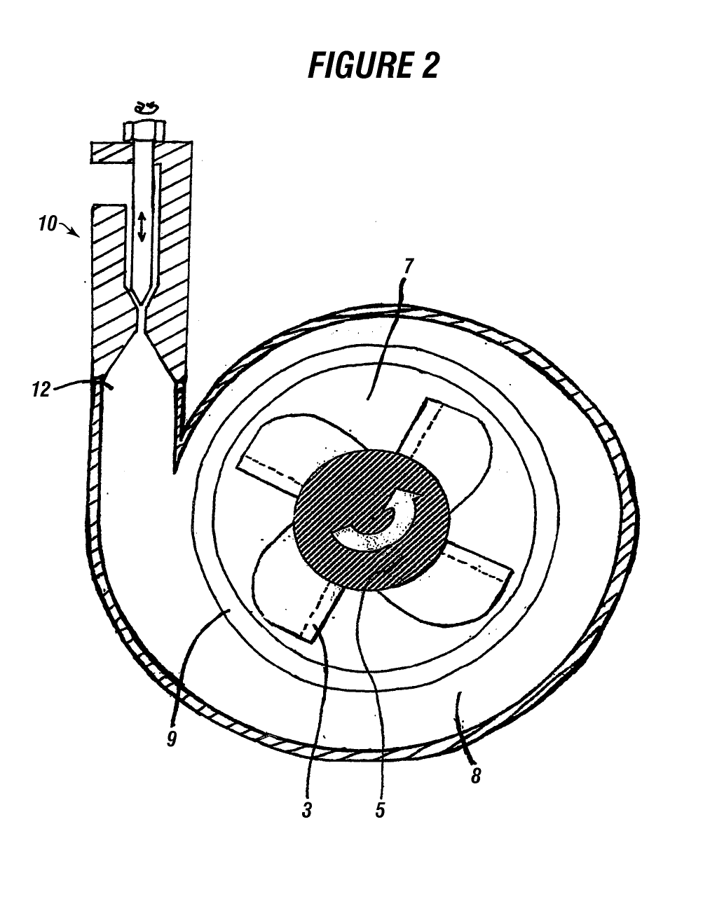

FIG. 2 is a schematic cross-sectional view of a granulating device according to a second embodiment for carrying out the method according to the invention.

A needle valve 10 with an adjustable nozzle opening is provided upstream of an inlet opening 12 for the coolant in the inlet chamber 8. The annular width of the opening of the needle valve 10 can be adjusted, such as by rotation of an adjusting screw of the needle valve 10, so that the needle valve can serve as a throttling arrangement for the gaseous cooling fluid entering the inlet chamber 8 and entering the cutting chamber 7 through the inlet nozzle arrangement 9. The fluid can adiabatically expand, and thus cool, while passing through the needle valve 10 when the annular width is suitable.

The inlet chamber 8 can have a cross-section that decreases over its circumference in the direction of rotation of the at least one blade 3, starting from an inlet opening 12 for the coolant in the inlet chamber 8.

In this embodiment, the inlet nozzle arrangement 9 is implemented as a continuous ring-shaped nozzle.

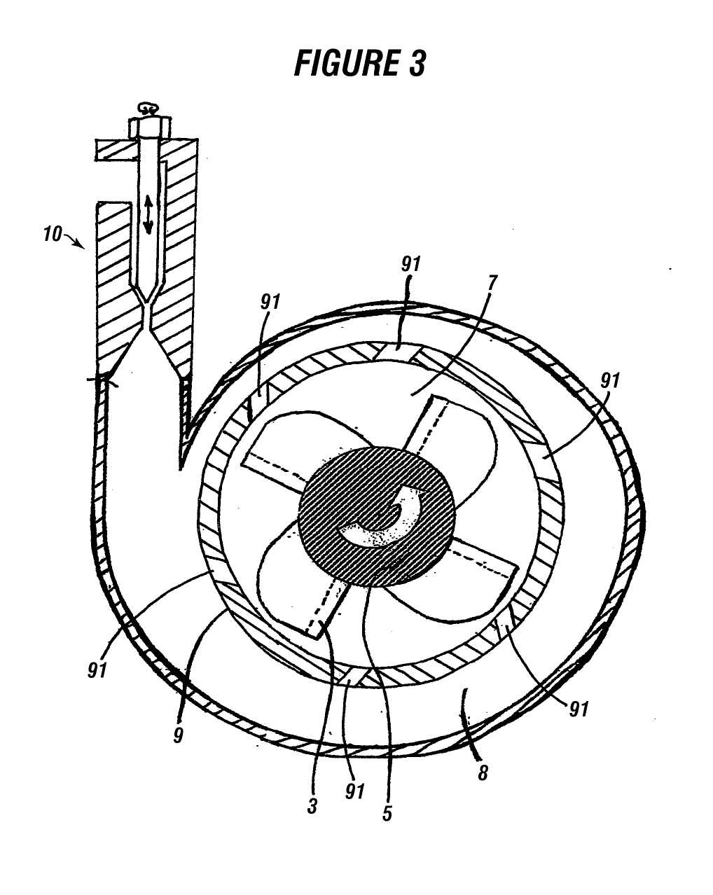

FIG. 3 is a schematic cross-sectional view of a granulating device according to a third embodiment for carrying out the method according to the invention.

The embodiment shown in FIG. 3 differs from the embodiment shown in FIG. 2 only in that the inlet nozzle arrangement 9 is not implemented as a continuous ring-shaped nozzle, but instead has multiple inlet nozzle openings 9a-9f around the circumference of the cutting chamber 7, permitting centripetal or substantially centripetal inflow of the gaseous coolant that is adiabatically cooled by the needle valve 10 serving as the throttling device.

The gaseous medium preferably can be purified and dehumidified process air that is delivered to the inlet chamber 8 directly (FIG. 1) through standard connections or through the needle valve 10 (FIG. 2 and FIG. 3).

In the figures, identical reference symbols are used to designate the same elements shown, with each of the statements made with respect thereto applying to all suitably designated elements and their equivalents. Any reasonable combination of elements shown in the different figures is possible.

The devices shown in the Figures serve to carry out the method according to the invention, for example for the application of manufacturing pharmaceutical products or pellets from a suitable melt material.

While these embodiments have been described with emphasis on the embodiments, it should be understood that within the scope of the appended claims, the embodiments might be practiced other than as specifically described herein.

What is claimed is:

1. A method for producing pellets from a melt material comprising:
a. flowing a melt material from nozzles in a perforated plate;
b. granulating the melt material;
c. cutting pellets of the melt material using a motor-driven cutter arrangement having at least one blade, wherein the motor-driven cutter arrangement is located opposite the perforated plate so that the at least one blade passes over the nozzles;
d. providing a cutting chamber in a housing, wherein the cutting chamber adjoins the perforated plate and encloses at least the at least one blade of the cutter arrangement;
e. flowing a gaseous coolant from an inlet apparatus to solidify the pellets of the melt material; and
f. cooling the gaseous coolant through adiabatic expansion by means of a throttling device.

2. The method for producing pellets of claim 1, wherein the adiabatic expansion is accomplished by means of the inlet apparatus implemented as a throttling device when the gaseous coolant enters the cutting chamber.

3. The method for producing pellets of claim 1, wherein the adiabatic expansion is accomplished by means of an upstream throttling device before the gaseous coolant enters the cutting chamber.

4. The method for producing pellets of claim 1, wherein the inlet apparatus is a separate inlet chamber that circumferentially encloses the cutting chamber in an area of rotation of the at least one blade, and comprises an inlet nozzle arrangement located circumferentially around the cutting chamber between the inlet chamber and a cutting chamber for introducing the gaseous coolant the cutting chamber circumferentially and substantially radially inward, and further wherein a substantially centripetal flow of the gaseous coolant is produced in the area of rotation, and conveying the gaseous coolant and pellets located therein to an outlet of the cutting chamber.

5. The method for producing pellets of claim 1, wherein pellets located in the gaseous coolant flow into a region of a cutting chamber outlet, where they are directed against a wall of the cutting chamber at an angle of less than 10 degrees, thereby imposing a rolling motion on the pellets located in the gaseous coolant.

6. The method for producing pellets of claim 1, wherein the gaseous coolant is air, an inert gas, or a reaction gas selected to enter into a desired chemical reaction with the melt material to be granulated.

7. A device for producing pellets from a melt material, comprising:
a. a perforated plate comprising a plurality of nozzles from which a melt material emerges;
b. a motor-driven cutter arrangement located opposite the perforated plate comprising a cutter head, wherein the cutter head comprises at least one blade and a cutter shaft, adapted for the at least one blade to pass over the plurality of nozzles in a rotating manner, thereby cutting the melt material into pellets;
c. a cutting chamber located within a housing, wherein the cutting chamber adjoins the perforated plate and encloses the at least one blade of the cutter head;
d. an inlet apparatus in fluid communication with the cutting chamber for introducing a coolant into the cutting chamber; and
e. a throttling device for cooling the gaseous coolant by adiabatic expansion.

8. The device for producing pellets of claim 7, wherein the inlet apparatus comprises:
a. an inlet chamber that circumferentially encloses the cutting chamber in an area of a rotation of the at least one blade; and
b. an inlet nozzle arrangement in fluid communication with the inlet chamber and the cutting chamber, wherein the inlet nozzle arrangement introduces the coolant to the cutting chamber circumferentially and substantially radially inward, and further wherein the inlet nozzle arrangement is an annular slot nozzle with an adjustable slot width; and
wherein a substantially centripetal flow of the coolant is produced in the area of rotation of the at least one blade, thereby conveying the coolant and pellets formed from the melt material to an outlet of the cutting chamber.

9. The device for producing pellets of claim 7, wherein the inlet chamber is lined with a thermally insulating material or a nonstick material.

10. The device for producing pellets of claim 7, wherein the thermally insulating material or the nonstick material comprises:
a. a tetrafluoroethylene;
b. a polytetrafluoroethylene; or
c. a vitreous enamel.

11. The device for producing pellets of claim 7, wherein the inlet nozzle arrangement comprises an annular slot nozzle having an adjustable slot width, thereby forming a throttling device.

12. The device for producing pellets of claim 7, wherein a needle valve with an adjustable opening is provided upstream of an inlet opening, thereby forming a throttling device.
